(19) United States
(12) Patent Application Publication
(10) Pub. No.: US 2018/0313308 A1
(43) Pub. Date: Nov. 1, 2018

(54) Hood Scoop Recirculation Tube

(71) Applicant: GM GLOBAL TECHNOLOGY OPERATIONS LLC, Detroit, MI (US)

(72) Inventor: Terry C. Bishop, Chesaning, MI (US)

(21) Appl. No.: 15/497,285

(22) Filed: Apr. 26, 2017

(51) Int. Cl. F02M 35/16; B60K 13/02; B62D 25/12; F02M 35/10

(52) U.S. Cl. CPC F02M 35/161; F02M 35/10026; B62D 25/12; B60K 13/02

(57) ABSTRACT

A system to improve cold air flow to an area of a vehicle is disclosed. The system includes an air induction plenum, an air inlet passage fluidicly connected to the air induction plenum, and an air outlet passage fluidicly connected to the air induction plenum, and a fan. The fan creates a fan pressure to pull air into the air induction plenum.

### INTRODUCTION

The present invention relates generally to the field of vehicles and, more specifically, to a cold air recovery system.

Cooler air delivered to an engine air induction system brings more oxygen into the combustion chamber, resulting in more power. When an engine operates in idle or under high load conditions, the engine generates heat that disperses throughout the engine compartment, resulting in decreased performance from additional systems, such as the air conditioning system.

### SUMMARY

Embodiments according to the present disclosure provide a number of advantages. For example, embodiments according to the present disclosure enable cold air delivery to an air induction plenum of a vehicle utilizing, in some embodiments, fan pressure to pull air from a cold air source.

In one aspect, a system to improve air flow to an engine and one or more other vehicle components includes an air intake member, an air induction plenum, an air inlet passage fluidicly connected to the air induction plenum and the air intake member, a first air outlet passage fluidicly connected to the air induction plenum and a second air outlet passage fluidicly connected to the air induction plenum, and a fan. The fan creates a fan pressure to pull air into the air induction plenum, the first air outlet passage directs air to the engine, and the second air outlet passage directs air to the one or more other vehicle components.

In some aspects, the intake member is a hood scoop.

In some aspects, the intake member is integrally formed with a hood of a vehicle.

In some aspects, the system further includes at least one sensor and a controller, the controller configured to receive sensor data from the at least one sensor indicating a temperature of a component to be cooled, determine whether the temperature of the component is above a predetermined threshold, and generate a control signal to initiate operation of the fan.

In some aspects, the air inlet passage is separated from the first and second air outlet passages by a length of the plenum.

In some aspects, air passes along the length of the plenum from the air inlet passage to one or more of the first and second air outlet passages.

In another aspect, an automotive vehicle includes a frame, an engine coupled to the frame, an air delivery system including an air intake member, a fan, an air induction plenum, an air inlet passage fluidicly connecting the air intake member to the air induction plenum, and at least one air outlet passage fluidicly connected to the air induction plenum, and a hood coupled to the frame, the hood defining a compartment for the engine and the air delivery system. The fan creates a fan pressure to pull air into the air induction plenum and the at least one air outlet passage directs air into the compartment.

In some aspects, the air intake member defines an ambient air inlet having a length transverse to a direction of travel of the vehicle.

In some aspects, the air intake member is integrally formed with the hood.

In some aspects, the air intake member is a hood scoop.

In some aspects, the automotive vehicle further includes at least one vehicle sensor and a controller. The controller is configured to receive sensor data from the at least one vehicle sensor indicating a temperature of the vehicle component, determine whether the temperature of the vehicle component is above a predetermined threshold, and generate a control signal to initiate operation of the fan.

In some aspects, the automotive vehicle further includes a first air outlet passage and a second air outlet passage. Each of the first and second air outlet passages is fluidicly connected to the air induction plenum, the first air outlet passage directs air towards the engine, and the second air outlet passage directs air towards one or more of a brake mount, an engine mount, one or more brake calipers, and a radiator.

In yet another aspect, a method to provide air to cool a vehicle component is disclosed. The method includes the steps of receiving, by a controller, sensor data from at least one vehicle sensor indicating a temperature of the vehicle component, determining, by the controller, whether the temperature of the vehicle component is above a predetermined threshold, and generating, by the controller, a control signal to initiate operation of a vehicle fan.

In some aspects, the method further includes the step of receiving, by the controller, sensor data from at least one vehicle sensor indicating an engine operating condition.

In some aspects, the method further includes the step of monitoring, by the controller, temperature data received from one or more temperature sensors.

### BRIEF DESCRIPTION OF THE DRAWINGS

The present disclosure will be described in conjunction with the following figures, wherein like numerals denote like elements.

FIG. 1 is a schematic overhead view of a hood compartment of a vehicle illustrating an air induction plenum fluidicly coupled to a hood scoop, according to an embodiment.

FIG. 2 is a schematic perspective view of a hood compartment of a vehicle illustrating an air induction plenum fluidicly coupled to a hood scoop, according to an embodiment.

FIG. 3 is a schematic side partial cut away view of a hood compartment of a vehicle illustrating an air induction plenum fluidicly coupled to a hood scoop, according to an embodiment.

FIG. 4 is a schematic block diagram of some components of a vehicle, according to an embodiment.

FIG. 5 is a flow chart of a method to initiate air cooling for a vehicle, such as the vehicles illustrated in FIGS. 1-4.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

High pressure within the engine compartment due to fan-induced pressures can cause hot air “reverse blowback” through a hood duct or any opening resulting in hot air recirculation into the air induction system. By providing an air flow path to the engine as discussed herein, cold air can be delivered to the air induction system as well as to an area where cool or cold air is desired, such as, for example and without limitation, forward of a condenser fan radiator module (CRFM), one or more engine mounts, one or more body mounts, or one or more brake calipers, while the engine is operating in a low speed or idle condition.

At low speed or idle conditions, the engine requires very little air to operate. However, during operation at these conditions, especially in hot weather locations, the engine generates a high amount of heat. The heat generated by the engine disperses throughout the engine compartment. Improved cooling benefits result when cool air is dumped in front of heat exchangers and air induction inlets, including improved performance of the air conditioning system, among other benefits.

Additionally, high pressure and hot engine compartment air and high mass air flow (MAF) demand under heavy trailer low speed accelerations can cause air induction plenum seals to be breached. The seal breach can cause hot air from under the hood to be sucked into the plenum and the air induction system. Embodiments discussed herein provide a cool or cold air recovery path to the air induction system that improve engine launch performance due to colder air intake temperatures using fan pressure during low speed engine operation to pull cool or colder air into an intake plenum.

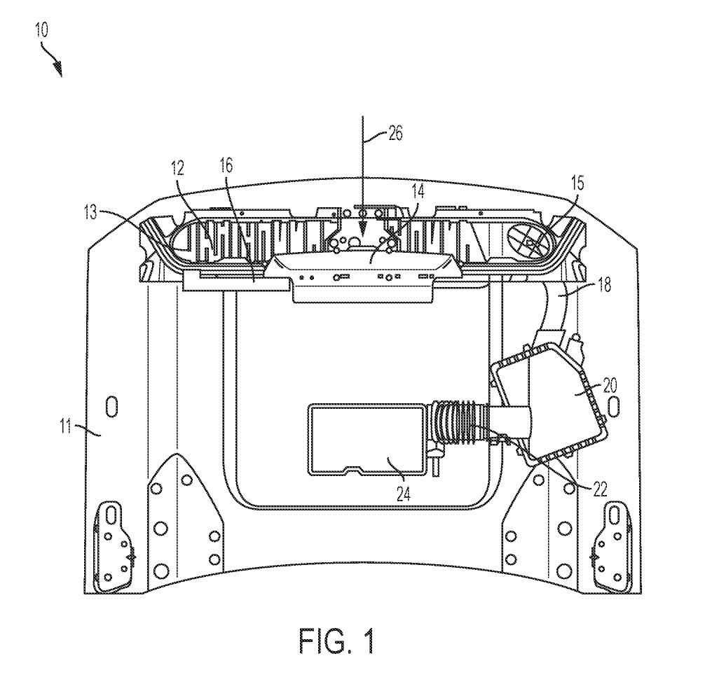

FIG. 1 is a schematic overhead view of a hood compartment of a vehicle 10 illustrating an air induction plenum 12 fluidicly coupled to a hood scoop 14, according to an embodiment. In some embodiments, the plenum 12 extends transverse to the front of the vehicle 10. The vehicle 10 includes a frame 11. An air inlet tube 16 connects the hood scoop 14 with the plenum 12. An air delivery tube 18 connects the plenum 12 with an airbox 20. In some embodiments, the airbox 20 includes a filter. A filtered air tube 22 connects the airbox 20 with the engine 24. As shown in FIG. 1, in some embodiments, the air inlet tube 16 directs air from the hood scoop 14 to the left, or driver side area 13 of the plenum 12. The air delivery tube 18 connects to the plenum 12 at the opposite, or right side area 15 of the plenum 12. Thus, air delivered to the plenum 12 from the hood scoop 14 travels the length of the plenum 12 before entering the air delivery tube 18.

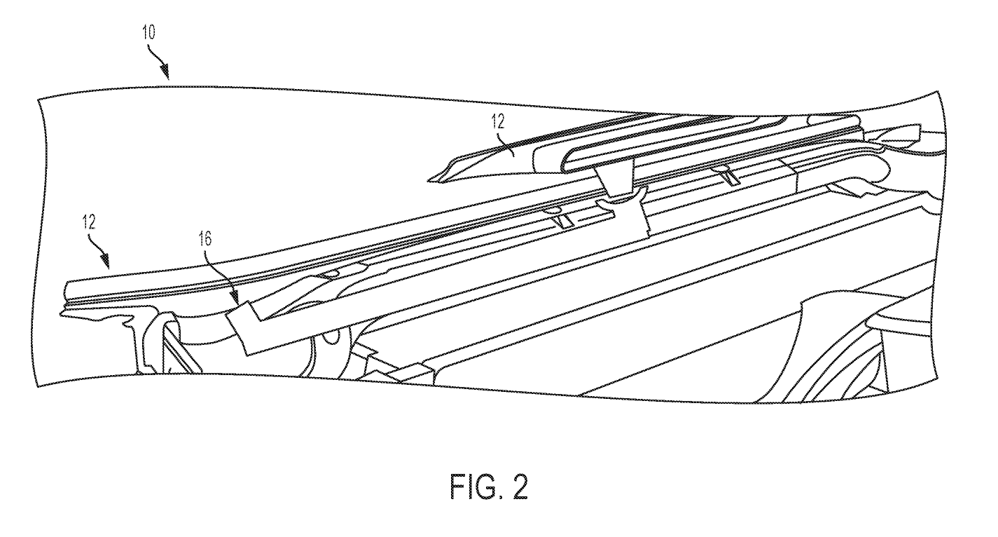

FIG. 2 further illustrates the air inlet tube 16 connecting the plenum 12 to the hood scoop 14. FIG. 2 illustrates the vehicle 10 from a position looking forward from the rear of the vehicle 10. In some embodiments, the air inlet tube 16 extends transverse to the front of the vehicle 10. In some embodiments, the air inlet tube 16 extends from the hood scoop 14 to an outboard corner of the plenum 12. As shown in FIG. 2, the hood scoop 14 is an ambient air inlet having a length that is transverse to a direction of travel of the vehicle 10. While the air inlet tube 16 is shown in FIG. 2 parallel to the length of the plenum 12, the air inlet tube 16 may be located in any other convenient location. In some embodiments, placement of the air inlet tube 16 depends on, for example and without limitation, packaging constraints.

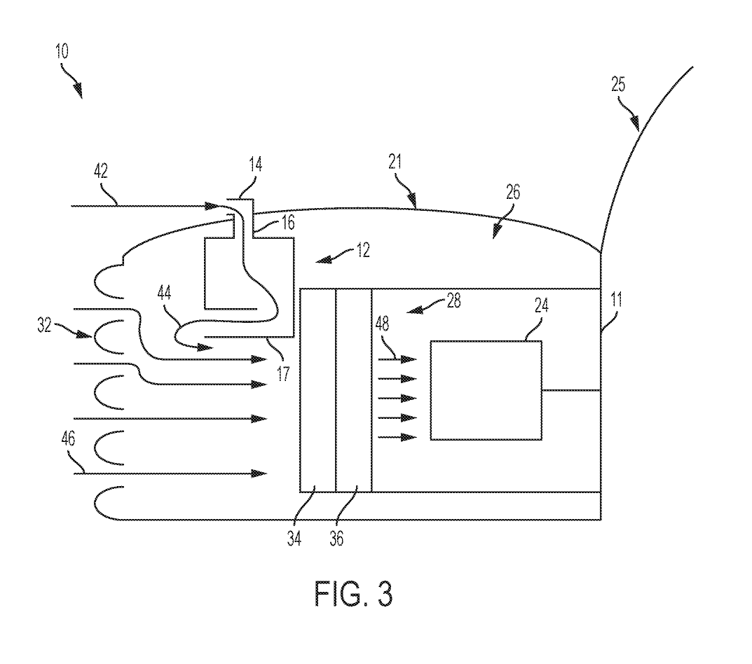

With reference to FIG. 3, in some embodiments, the vehicle 10 includes a hood 21 coupled to the frame 11. The hood 21 defines a compartment 26 for an engine 24 and an air delivery system 28. In some embodiments, the air delivery system 28 includes the hood scoop 14, a radiator 34, a fan 36, the plenum 12, the air inlet tube or passage 16, and an air outlet tube or passage 17, as well as the air delivery tube 18 and the airbox 20, shown in FIG. 1. In some embodiments, vehicle components including a windshield 25, the engine 24, and a forward grille 32 are coupled, directly or indirectly, to the frame 11. The hood 21 allows access to components disposed within the compartment 26, including the air induction plenum 12, the radiator 34, the fan 36, and the engine 24.

As illustrated in FIG. 3, the plenum 12 is fluidicly coupled to the hood scoop 14 by the air inlet tube 16. Air, shown by arrow 42, enters the hood scoop 14 and passes into the air inlet tube 16. The air inlet tube 16 directs air from the hood scoop 14 into the plenum 12. In some embodiments, the plenum 12 has two air outlet passages or tubes. As shown in FIG. 1, air from plenum 12 is supplied to the engine airbox 20 via the air delivery tube 18. Additionally, air can also pass through the plenum 12 and enter the air outlet passage or tube 17. In some embodiments, the air outlet passage 17 is a snow baffle to avoid snow ingestion. As shown in FIG. 3, the air outlet passage 17 directs air generally away from the engine 24 in a direction generally opposite to a direction of air coming into the compartment 26 through the forward grille 32 (indicated by arrow 46); however, in other embodiments, air from the plenum 12 could be directed into the compartment 26 in any direction. Cold or cooler air drawn in through the hood scoop 14 or other opening, through the plenum 12, and delivered to the interior of the compartment 26 via the outlet passage 17 passes through the radiator 34 and is directed towards the engine 24 (indicated by arrows 48).

The fan 36 creates a fan pressure that starves, or pulls, air from the plenum 12 during engine idle or low speed conditions. Starving the plenum 12 results in air being drawn into the plenum 12 via the air inlet tube 16 from the hood scoop 14 or from another cold air source, such as an opening near the front fender, for example and without limitation. The cold or cooler air drawn into the plenum 12 by the fan pressure created by the fan 36 provides cold or cooler air to the engine 24 and also to another location where cool air is desired, such as in front of the condenser radiator fan module (CRFM) or other location to counteract hot thermal recirculation, that is, heat generated when the engine is at low speed or operating under high load towing conditions or when the engine 24 is idling. When the engine 24 is operating at idle or at a low speed, the temperature of the air delivered to the engine 24 by the air induction system 28 is typically warm due to a lack of air flow from movement of the vehicle 10. It is well known that the engine 24 does not operate most efficiently under these conditions. The systems discussed herein provide a source of cold or cooler air to the air induction system 28 by starving the plenum 12 of air and thus drawing air into the plenum 12 and the air induction system 28 from a cold or cooler air source such as, for example and without limitation, an air inlet located on the vehicle hood (that is, the hood scoop 14). In some embodiments, air is drawn into the plenum 12 from another cool or colder air location, such as, for example and without limitation, the side of the vehicle 10, a fender of the vehicle 10, the glove box, etc.

As shown in FIG. 3, air from the air outlet 17 of the plenum 12 is cool or colder air that is provided to both a position forward of the radiator 34 and to the engine 24. Providing cool or colder air forward of the radiator 34 improves the efficiency of the air conditioning system, among other benefits. As discussed herein, air drawn into the plenum 12 by the fan 36 is also directed to the combustion chambers of the engine 24 via the air passage 18 and the airbox 20 shown in FIG. 1. Providing cool or colder air to the combustion chambers of the engine 24 improves engine performance and durability. In some embodiments, air from the air outlet 17 is directed toward the engine to cool the engine block or toward other vehicle components such as, for example and without limitation, engine and body mounts and brake calipers.

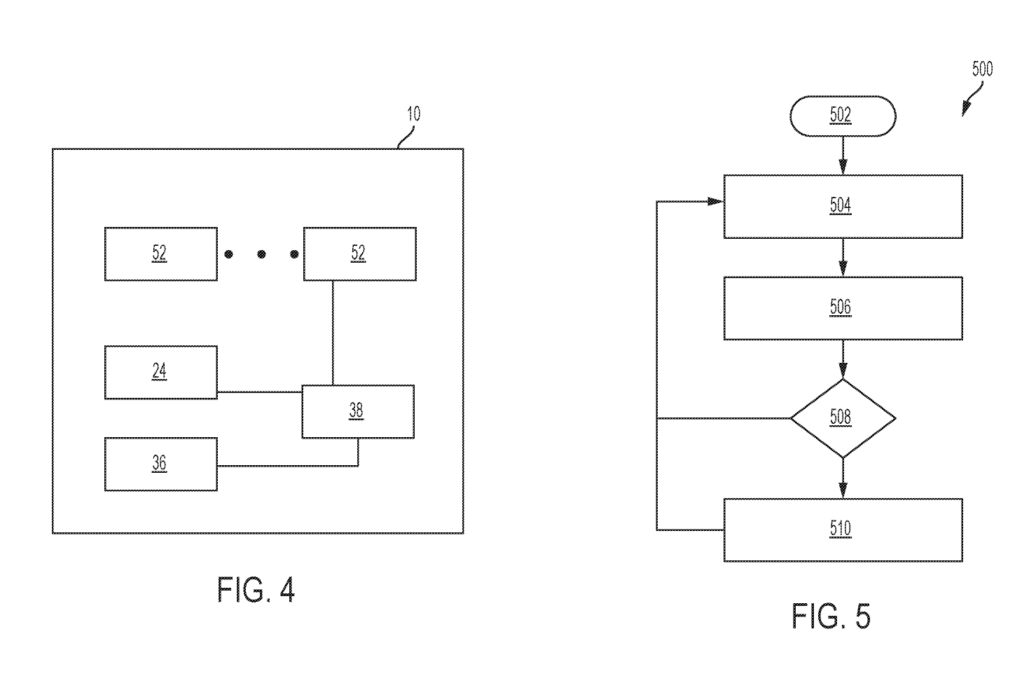

FIG. 4 schematically illustrates some additional and optional components of the vehicle 10. As shown in FIG. 4, in some embodiments, the engine 24 and the fan 36 are electrically connected to at least one controller 38. While depicted as a single unit for illustrative purposes, the controller 38 may additionally include one or more other controllers, collectively referred to as a “controller.” The controller 38 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 38. In some embodiments, the vehicle 10 includes a plurality of sensors 52, which may include optical cameras, thermal cameras, ultrasonic sensors, temperature sensors, fan speed sensors, and/or additional sensors as appropriate. The plurality of sensors 52 are electrically connected to the controller 38. In some embodiments, as discussed in greater detail herein, the controller 38 receives sensor data from the plurality of sensors 52 and determines, based on the sensor data, a fan speed setting.

FIG. 5 illustrates a method 500 to provide air to an area to be cooled when the engine is operating in an idle or low speed condition. The method 500 can be utilized in connection with the vehicle 10, the controller 38, the fan 36, and the plurality of sensors 52, discussed herein with respect to FIGS. 1-4, in accordance with exemplary embodiments. As can be appreciated in light of the disclosure, the order of operation within the method 500 is not limited to the sequential execution as illustrated in FIG. 5, but may be performed in one or more varying orders as applicable and in accordance with the present disclosure. In some embodiments, the method 500 may include more or fewer steps than those shown in FIG. 5.

The method 500 begins at start block 502 and proceeds to 504. At 502, the controller 38 receives sensor data from at least one of the plurality of sensors 52 indicating a temperature of a vehicle component or area to be cooled. In some embodiments, the sensor data indicates a temperature of the engine 24, an engine mount, or a body mount, for example and without limitation. Next, at 506, the controller 38 receives sensor data from at least one of the plurality of sensors 52 indicating an engine operating condition. For example, in some embodiments, the sensor 52 indicates that the engine 24 is operating in an idle or low speed condition.

At 508, the controller 38 determines whether the sensor data indicates that the measured temperature is above a predetermined threshold temperature. The threshold temperature is determined based on the component being measured. For example and without limitation, the threshold temperature for the engine 24 may be different from the threshold temperature for an engine mount or a body mount.

If the measured temperature of the component is above the threshold temperature, the method 500 proceeds to 510. At 510, the controller 38 generates a control signal that is transmitted to the fan 36 to operate the fan 36 at a predetermined fan speed. In some embodiments, the predetermined fan speed is based on one or more factors, including the size of the fan, the measured temperature of the component, the type of component to be cooled, etc. for example and without limitation. The method 500 then returns to 504 and the controller 38 continues to monitor the temperature information received from one or more temperature sensors 52.

If the measured temperature of the component is not above the threshold temperature, the method 500 returns to 504 and the controller 38 continues to monitor the temperature information received from one or more temperature sensors 52.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A system to improve air flow to an engine and one or more other vehicle components, comprising:
an air intake member;
an air induction plenum;
an air inlet passage fluidicly connected to the air induction plenum and the air intake member;
a first air outlet passage fluidicly connected to the air induction plenum and a second air outlet passage fluidicly connected to the air induction plenum; and
a fan;
wherein the fan creates a fan pressure to pull air into the air induction plenum, the first air outlet passage directs air to the engine, and the second air outlet passage directs air to the one or more other vehicle components.

2. The system of claim 1, wherein the intake member is a hood scoop.

3. The system of claim 2, wherein the intake member is integrally formed with a hood of a vehicle.

4. The system of claim 1 further comprising at least one sensor and a controller, the controller configured to receive sensor data from the at least one sensor indicating a temperature of a component to be cooled, determine whether the temperature of the component is above a predetermined threshold, and generate a control signal to initiate operation of the fan.

5. The system of claim 1, wherein the air inlet passage is separated from the first and second air outlet passages by a length of the plenum.

6. The system of claim 5, wherein air passes along the length of the plenum from the air inlet passage to one or more of the first and second air outlet passages.

7. An automotive vehicle, comprising:
a frame;
an engine coupled to the frame;
an air delivery system comprising an air intake member, a fan, an air induction plenum, an air inlet passage fluidicly connecting the air intake member to the air induction plenum, and at least one air outlet passage fluidicly connected to the air induction plenum; and
a hood coupled to the frame, the hood defining a compartment for the engine and the air delivery system;
wherein the fan creates a fan pressure to pull air into the air induction plenum and the at least one air outlet passage directs air into the compartment.

8. The automotive vehicle of claim 7, wherein the air intake member defines an ambient air inlet having a length transverse to a direction of travel of the vehicle.

9. The automotive vehicle of claim 7, wherein the air intake member is integrally formed with the hood.

10. The automotive vehicle of claim 9, wherein the air intake member is a hood scoop.

11. The automotive vehicle of claim 7 further comprising at least one vehicle sensor and a controller, the controller configured to receive sensor data from the at least one vehicle sensor indicating a temperature of the vehicle component, determine whether the temperature of the vehicle component is above a predetermined threshold, and generate a control signal to initiate operation of the fan.

12. The automotive vehicle of claim 7 further comprising a first air outlet passage and a second air outlet passage, wherein each of the first and second air outlet passages is fluidicly connected to the air induction plenum, the first air outlet passage directs air towards the engine, and the second air outlet passage directs air towards one or more of a brake mount, an engine mount, one or more brake calipers, and a radiator.

13. A method to provide air to cool a vehicle component, the method comprising:
receiving, by a controller, sensor data from at least one vehicle sensor indicating a temperature of the vehicle component;
determining, by the controller, whether the temperature of the vehicle component is above a predetermined threshold; and
generating, by the controller, a control signal to initiate operation of a vehicle fan.

14. The method of claim 13 further comprising receiving, by the controller, sensor data from at least one vehicle sensor indicating an engine operating condition.

15. The method of claim 13 further comprising monitoring, by the controller, temperature data received from one or more temperature sensors.
